(19) United States
(12) Patent Application Publication
(10) Pub. No.: US 2008/0302725 A1
(43) Pub. Date: Dec. 11, 2008

(54) Modulated Bundle Element

(75) Inventors: Xianshe Feng, Waterloo (CA); Darren Lawless, Oakville (CA)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Imbrium Systems Corp.

(21) Appl. No.: 12/134,774

(22) Filed: Jun. 6, 2008

Related U.S. Application Data
(60) Provisional application No. 60/942,284, filed on Jun. 6, 2007.

(51) Int. Cl. B01D 39/02; B01D 15/00; B01D 39/14

(52) U.S. Cl. 210/660; 210/435; 210/749; 210/502.1; 210/504

(57) ABSTRACT

An apparatus for the adsorption of components of fluids or the catalytic reaction of components of fluids. The apparatus has numerous membranous elements formed as fibers, strands, strips, or the like. Each element possesses a desirable property such as the ability to adsorb certain components of a fluid or the ability to catalyze a particular chemical reaction. The elements are packaged into bundles of elements structured such that sufficient space exists between individual elements to allow for the flow of a fluid through the bundle. The bundle is contained within an impermeable casing containing one or more inlet ports and one or more outlet ports. The elements may have materials that are able to adsorb specific substances. The elements also may have materials that are able to catalyze certain chemical reactions.

### PRIORITY CLAIM

The present invention claims the benefit of U.S. Provisional Application No. 60/942,284, filed Jun. 6, 2007, the contents of which are incorporated herein by reference.

### FIELD OF THE INVENTION

This invention relates to a module packed with a bundle of fibers, filaments, strands, threads, strips or the like arranged to provide effective contact and interaction between the bundle elements and a particular component or components of a fluid system. Depending on the adsorptive or catalytic properties of the bundle element, such a module may be used as an adsorber or a catalytic reactor.

### BACKGROUND OF THE INVENTION

Processes based on the unit operations of fluid-solid contact and interaction are widely used in the chemical processing industry. Fluid separations by adsorption on solid adsorbent and catalytic reactions using solid catalysts are two of the most prominent examples. Adsorption processes are widely used in industry for separation and purification of liquid or gaseous mixtures. The separation is based on selective adsorption of adsorbable components on the active sites of the solid adsorbent. The commonly used adsorbents include microporous activated carbon, alumina, silica gel and zeolites, for which the active sites for sorption are located predominately on the internal pore walls of the porous adsorbent. For certain adsorption applications, the adsorbent may be made from polymeric materials with ion exchange or chelating properties, where the sorption may occur on the external surface and in the interior of the adsorbent.

For efficient adsorption, the adsorbent is traditionally used in the form of cylindrical or spherical particles. Most industrial adsorption processes are carried out in fixed-bed type columns, where the adsorbent particles are packed and immobilized in the column. As a fluid mixture to be separated or purified is passed through the adsorbent packing via the void spaces among the adsorbent particles, the adsorbable components in the fluid mixture are taken up and retained by the adsorbent. Apart from the adsorptive capacity of the adsorbent, which is mainly determined by the material chemistry of the adsorbent, there are two important engineering factors that affect the efficiency of the fluid-solid interaction: one is the mass transfer rate between the bulk fluid and the active particle surface and the other is the pressure drop through the packed bed contactor.

The rate of mass transfer is determined by the resistance encountered by the fluid during the course of transport between the bulk phase of the fluid and the active surface of the particles. Both the intraparticle resistance due to pore diffusion within the particle and the external film resistance due to the fluid boundary layer surrounding the particle may be operative. Under practical conditions, the film resistance rarely plays a major role, and the intraparticle mass transfer resistance normally controls the overall mass transfer rate. For adsorption separation, as a fluid mixture is passed through the adsorbent bed, certain components in the mixture preferentially adsorb onto the active surfaces of the adsorbent. The adsorbent bed can thus be divided into three zones: an adsorbate-saturated zone, a mass transfer zone, and a clean adsorbent zone. In the mass transfer zone, dynamic adsorption occurs and the adsorbent is partially saturated with the adsorbate. This zone migrates towards the adsorber outlet, and consequently the adsorbent-saturated zone becomes larger and the clean bed zone becomes smaller. The adsorption should be stopped before the concentration front reaches the adsorber exit in order to prevent the breakthrough of adsorbate. Then, the adsorber is subjected to desorption of adsorbed species for regeneration of adsorbent and recovery of adsorbate. The mass transfer rate of adsorption determines the length of the mass transfer zone in the adsorber, influencing the efficiency of adsorbent utilization. The desorption rate, on the other hand, determines the time and/or purge volume required for the regeneration, influencing the fractional online time of the adsorber for adsorption. Fast mass transfer generally results in sharp separation. For catalytic reaction, the mass transfer of reactant occurs from the bulk phase to the catalytically active surface of the catalyst, where adsorption and reaction take place. The product formed will diffuse back to the bulk fluid. Similar to the case of adsorption separation, both intraparticle and interparticle mass transfer resistances affect the efficiency of the catalytic reaction.

One of the major variables in fixed bed adsorbers is the particle size. The particle size has a significant effect on the process performance. Reducing the particle size will decrease the intraparticle resistance to mass transfer and increase the specific external surface area for fluid-solid contacts, and thereby the mass transfer rate can be enhanced. However, as the particle size decreases, the particles pack closer and the space between adjacent particles decreases. As a result, the pressure drop through the packed bed increases at a given flow rate. A high pressure drop not only leads to increased pumping or compression costs but may also cause attrition of the particles, uneven distribution of the fluid flow, bed shifting for up flow (and even fluidization of the particles when the pressure drop is excessively high) or bed crushing for down flow. Consequently, the minimum particle size that can be used effectively in the packed bed is limited by the hydrodynamic operating conditions in order to prevent an excessive pressure drop. The same concerns also apply to catalytic reaction processes. Therefore, commercial packed bed operations generally use a particle size greater than 2-3 mm in equivalent diameter. Particles with smaller sizes (e.g., molecular sieve zeolite crystals) are normally pelletized to form agglomerates of proper sizes using binding materials.

Thus, decreasing the particle size has a desirable effect on the mass transfer rate, but an undesirable effect on the pressure drop. Smaller adsorbent particles improve the efficiency of mass transfer while simultaneously increasing the pressure drop through the system. Accordingly, the minimum particle size is limited by acceptable hydrodynamic operating conditions of the fixed-bed adsorber. This relationship between more efficient mass transfer and undesirable pressure drops caused by smaller particle size also applies to other processes requiring effective contact and interaction between a fluid stream and solid particles, such as a heterogeneous catalytic reaction process involving an adsorption step in the reaction mechanism. The use of small catalyst particles will enhance mass transfer between the catalyst and surrounding fluid carrying the reactants, but it will also increase pressure drop through the reactor bed.

Two unconventional fixed-bed modules disclosed in U.S. Pat. Nos. 5,139,668 (Pan and McMinis) and 5,693,230 (Asher) can use small particles without causing an excessively high pressure drop. In both cases, porous hollow fibers are used to immobilize minute solid particles inside the fiber lumina. The void spaces between the fibers provide an unobstructed passageway for fluid flow so as to maintain a low pressure drop. Essentially, the small particles are confined in the hollow fibers arranged longitudinally. However, such a module requires expensive and delicate hollow fibers to construct, and special facilities and procedures are often required to pack the particles inside hollow fibers. Additionally, the space available within the module that can be packed with adsorbent is typically low because the hollow fibers themselves occupy a significant portion of the total available space within the module. More importantly, such a design is not particularly suitable for circumstances where the fluid will cause swelling of the adsorbent materials. This is often the case for water purification using polymeric adsorbent or adsorbent-containing polymeric binders for removing impurities. Because the adsorbent is confined inside the hollow fibers, the adsorbent swelling will force the fibers to expand, resulting in compromised performance due to reduced passageways for the fluid flow. For severe adsorbent swelling by the fluid, the hollow fibers may burst, causing disintegration of the absorber module. A further disadvantage of the hollow fiber-modulated adsorber is that it the hollow fiber walls offer additional resistance to mass transfer from the fluid to the adsorbent. While such resistance may not be significant for treatment of gaseous mixtures using hollow fibers with micron-sized pores, it may be critical for liquid treatment because of the much higher viscosities.

Accordingly, exemplary objects of the present invention are: to provide a module that can function for effective fluid/adsorbent contact and interaction using adsorbent in the form of a bundle of fibers, filaments, strands, threads, strips or the like; to provide a module with adsorbent arranged longitudinally so as to allow the fluid to be treated to pass along the adsorbent, but without the need of additional retainer to hold the adsorbent in place; to provide a module with adsorbent that can tolerate swelling and/or shrinking in the fluid mixtures without affecting the module integrity; to provide a module with adsorbent materials in which foulants and deposits on the adsorbent surface can be easily removed or cleaned; and, to provide a module with a high mass transfer rate for sorption and desorption and with a low pressure drop especially suitable for treatment of liquid mixtures. Some or all of the foregoing objectives may be accomplished by embodiments of the invention described herein.

### SUMMARY OF THE INVENTION

In one exemplary embodiment, the present invention may provide a module comprising a bundle of fibers, filaments, strands, threads, strips or the like which are contained in an impermeable shell casing. Some or all of the constituents in the bundle may be used to provide interaction between the bundle and a component or components in a feed stream. The feed stream is a fluid that may comprise material in the gas or liquid phase. The constituents of the bundle are fibers, filaments, strands, threads, strips, or the like possessing properties that are desirable for adsorption and/or catalysis. These fibers, filaments, strands, strips, or the like that constitute the bundle are hereinafter referred to as the “elements” of the bundle. The desirable properties of the elements, i.e., their ability to adsorb substances or to catalyze chemical reactions, may be provided by active materials that are inherent in the material of which the element is made. Alternatively, the desirable properties of the elements may be attributed to substances or materials that are affixed to the fiber, filament, strand, thread, strip, or the like that constitutes the body of the element. Substances or materials also may be provided in the elements by embedding them or impregnating them into the structure and/or material that forms the elements. If desired, multiple different kinds of material may be used in the elements to provide different adsorption or catalytic properties.

The elements of a bundle may be arranged randomly or in any pattern that provides sufficient empty spaces between the elements of the bundle to provide passageways for the fluid stream to reach and interact with the elements. At each end of the bundle, the elements may be held together by epoxy or any other appropriate resin materials. The bundle may be placed into a module with any possible orientation with respect to the flow of fluid through the bundle.

In one embodiment, the module may be used as an adsorber. The fluid stream contains an adsorbate, and the bundled elements are adapted to adsorb the adsorbate from the fluid stream as it flows through the module. As a result, the adsorbate is retained in the module, and a fluid stream depleted of the adsorbate is obtained, thereby achieving the separation of the adsorbate from the fluid stream. The adsorbate-laden bundle elements may be subjected to regeneration by desorbing the adsorbate under reduced pressures, at an elevated temperature, and/or with the aids of a purging fluid.

In another embodiment, the module may be used as a catalytic reactor. In this case, the bundled elements function as catalyst, and the fluid stream containing reactants passes through the module to catalyze reaction between the reactants. The reaction products in the end stream exit the module.

### BRIEF DESCRIPTION OF THE DRAWINGS

Exemplary embodiments of the invention are illustrated and described in the attached drawings, in which:

FIG. 1 shows breakthrough curves for adsorption of CUSO₄, Pb(NO₃)₂ and K₂CrO₄ with a flow rate of 1 ml/min and feed concentration of 5 g/L.

FIG. 2 shows desorption curves of CuSO₄, Pb(NO₃)₂ and K₂CrO₄ using 3 g/L of EDTA solution as stripping fluid, a chitosan strip thickness of 0.015 mm and an EDTA flow rate of 1 ml/min.

FIG. 3 shows an exterior view of a module with casing, fluid entrance port (inlet), and fluid exit port (outlet).

FIG. 4 shows a cross-sectional view of a module with elements arranged parallel to one another and the bundle of elements oriented along the axis defined by the inlet (not shown) and the outlet.

FIG. 5 shows a side-on cross-sectional view of a module with elements arranged parallel to one another and the bundle of elements oriented along the axis defined by the inlet and the outlet.

FIG. 6 shows a side-on cross-sectional view of a module with elements arranged parallel to one another and the bundle of elements oriented perpendicular to the axis defined by the inlet and the outlet.

FIG. 7 shows a cross-sectional view with cut-away of a module with elements arranged perpendicular to a central axis and the bundle of elements oriented parallel to an axis running between the inlet and the outlet.

FIG. 8 shows a cross-sectional view of a module with elements arranged perpendicular to a central axis and the bundle of elements oriented perpendicular to an axis running between the inlet and the outlet.

FIG. 9 shows a partially cut away side view of a module with elements arranged into a bundle where the elements are oriented randomly with respect to one another.

### DETAILED DESCRIPTION OF PREFERRED EMBODIMENTS

The present invention generally provides new methods and apparatus for treating a fluid flow stream to remove pollutants by adsorption, or to generate a catalytic reaction in the fluid flow stream. The invention may be used with liquid or gaseous fluid flows, or a mixture of fluids. In general terms, embodiments of the invention provide a bundle of elongated adsorption or catalyzing elements located in a casing through which the fluid is passed for treatment. These elements may be provided individually, or joined together in one or more bundles of fibers, filaments, strands, threads, strips, or the like possessing properties that are desirable for adsorption and/or catalysis. The desirable properties of the elements, i.e., their ability to adsorb substances or to catalyze chemical reactions, may be inherent in the material of which the element is made. Alternatively, the desirable properties of the elements may be attributed to substances or materials that are affixed to, embedded in, or impregnated in the fiber, filament, strand, thread, strip, or the like that constitutes the body of the element.

### EXAMPLES

The following examples are provided to illustrate exemplary modulated fiber elements and are not intended to limit in any way the scope of the present invention.

### Example 1

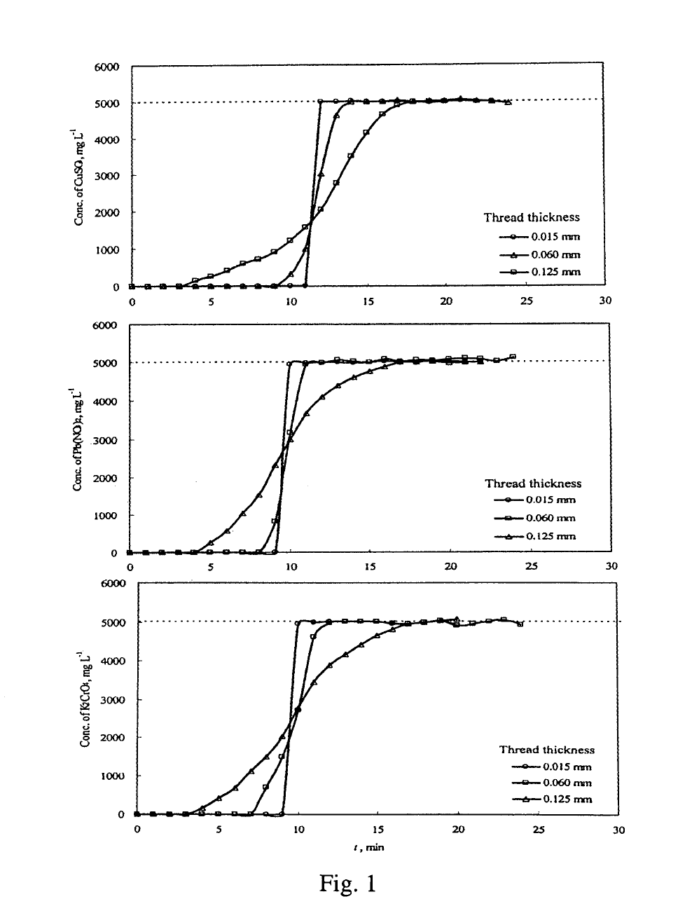

Chitosan membranes with thicknesses of 0.015, 0.060 and 0.125 mm were cut to thin strips with a width of 1.5 to 2.0 mm. A bundle of the chitosan strips was packed in a glass tube (diameter 0.4 cm, length 15 cm) to form an adsorption column. Three element bundles were formed and tested for removal of metal ions from aqueous solutions. The elements contained 0.180 g dry chitosan for CuSO₄ and Pb(NO₃)₂ adsorption, and 0.280 g dry chitosan for K₂CrO₄ adsorption, respectively. Various feed water flow rates (1, 3 and 5 ml/min) and adsorbate concentrations (5, 12 and 24 g/L for CuSO₄ and Pb(NO₃)₂, and 5, 10 and 24 g/L for K₂CrO₄) were used. Concentration of the effluent was monitored using a conductivity meter. FIG. 1 shows the breakthrough curves for the adsorption of the metals in the columns containing chitosan strips of different thicknesses. When the thickness of the strips decreased, the adsorbate concentration in the outflow reached the initial concentration faster, and the breakthrough curves were sharper. At a feed flow rate of 1 ml/min, the breakthrough time was 3 min for the adsorption of CuSO₄ and Pb(NO₃)₂, and 4 min for the adsorption of K₂CrO₄ when the chitosan adsorbent thickness was 0.125 mm. If the strip thickness was decreased to 0.015 mm, the breakthrough time was increased to 11 min for CuSO₄ adsorption, 9 min for Pb(NO₃)₂ and K₂CrO₄ adsorption. This demonstrates the decreased mass transfer resistance by the use of smaller adsorbent strips. As discussed previously herein, decreasing the mass transfer resistance will enhance the adsorption mass transfer rate, so that more adsorbate will be taken up in the column at a given time prior to breakthrough. This further shows the advantage of using thin adsorbent strips in order to improve the adsorption efficiency.

### Example 2

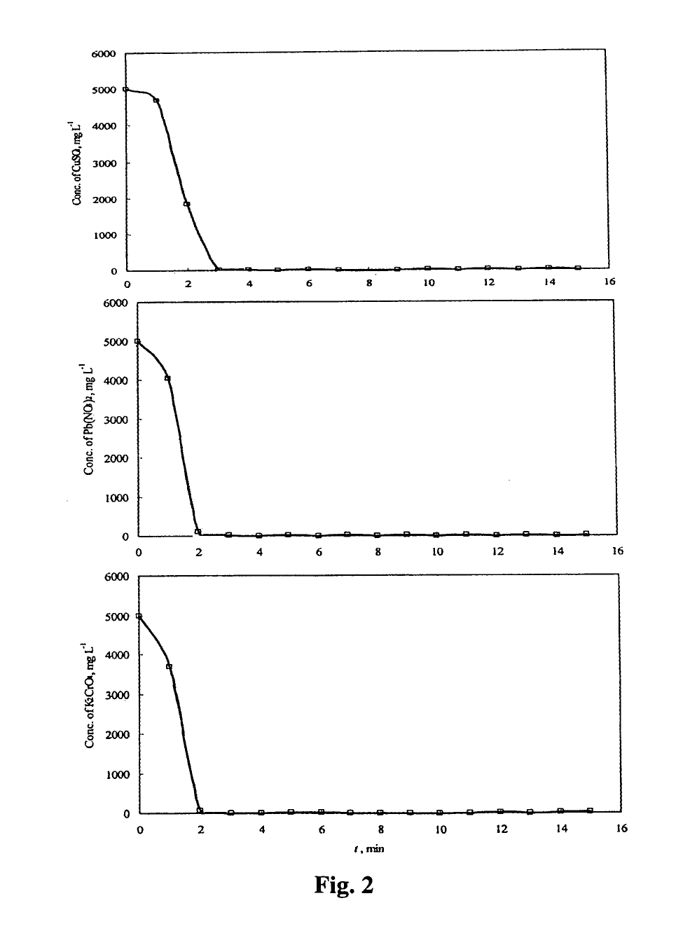

After the adsorption columns were saturated with adsorbates, the columns were regenerated by stripping the adsorbate retained in the columns with an aqueous ethylene diamine tetraacetic acid (“EDTA”) solution at a concentration of 3 g/L so that desorption would occur. FIG. 2 shows the desorption curves for the columns containing 0.015 mm thick chitosan strips. Consistent with the adsorption breakthrough curves, the desorption curve is rather sharp, suggesting the fast mass transfer during desorption by the use of thin adsorbent strips.

### Example 3

Chitosan fibers of different diameters (0.04-0.6 mm) were produced and tested for metal removal from water. Similar results were observed for these embodiments.

### Example 4

Chitosan fibers were produced and impregnated with AgNO₃ by contacting a 3 M aqueous AgNO₃ solution. A gas mixture of propylene and propane was admitted to a column containing the fibers, and a sharp breakthrough curve was observed for the adsorption of propylene by the silver-containing water-wet fibers. This illustrates the utility of embodiments of the invention for use with gaseous fluids, as well as liquids.

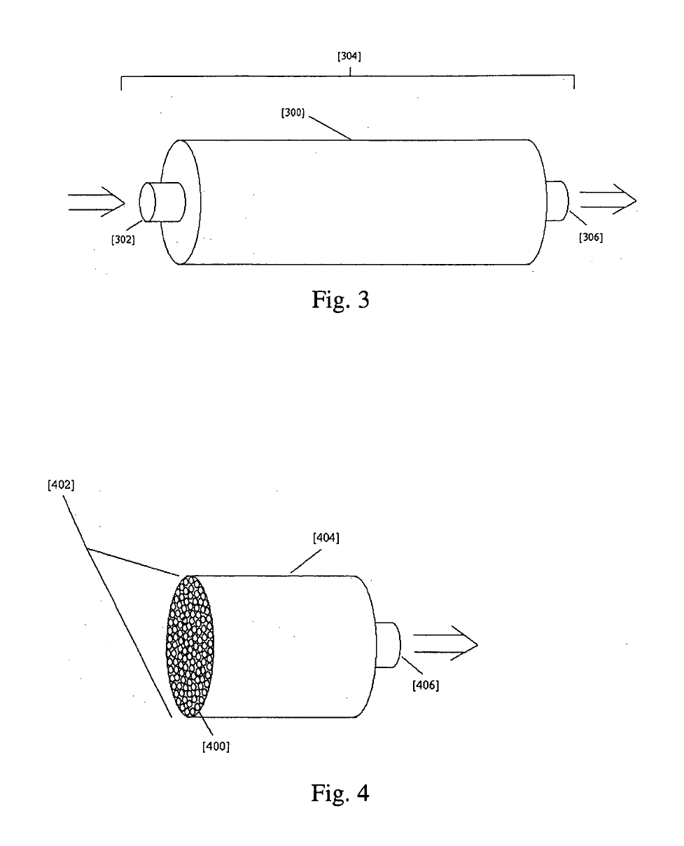

Embodiments of the present invention may be provided in any number of physical configurations. In a preferred embodiment, the elements are arranged into one or more bundles, which may be held together in any suitable way, and one or more bundles are provided in a casing through which the fluid is passed. An exemplary module is illustrated in FIG. 3, in which an elongated bundle is encased in a shell containment or casing 300 with end closures. At least one fluid entrance port, or inlet, 302 is provided at one end of the module to direct fluid flow into the module 304, and at least one fluid exit port, or outlet, 306 is provided at the other end of the module for fluid discharge. Various examples of details of this embodiment are provided as follows.

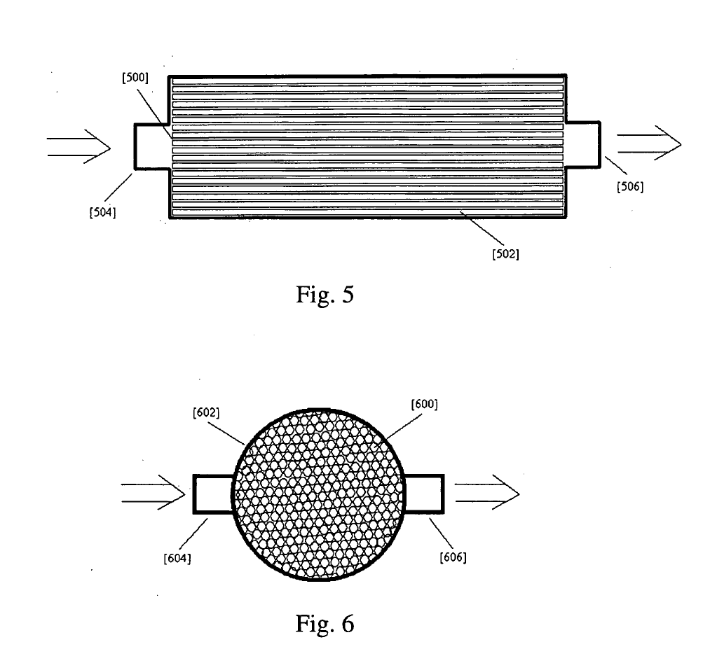

In one embodiment of the invention, illustrated in FIGS. 4 and 5, the elements 400 of the bundle 402 are arranged longitudinally such that the long axes of a majority of the elements are roughly parallel to one another. The elements of the bundle may be held together using any appropriate adhesive applied either to the end of the bundle or distributed throughout the bundle. Alternatively, the elements of the bundle may be held together by any form of compression band or bands positioned around the bundle of elements, or by any other device, as will be understood by persons of ordinary skill in the art in view of the present disclosure.

The bundle of elements is placed into the casing 404 of a module so that the long axis of the bundle runs between the end of the casing containing the fluid inlet and the opposite end of the casing containing the fluid outlet 406. Fluid passes through the spaces 500 around the elements 502 and contacts the surfaces of the elements as it flows from the inlet 504 to the outlet 506 port. The elements may comprise materials capable of adsorbing either components of the fluid or materials carried by the fluid. Alternatively, the elements may comprise materials capable of catalyzing reactions between components of the fluid and/or between materials carried by the fluid. This embodiment may be modified in any number of ways, such as by twisting the bundle of elements into a helical shape having a central core or no central core.

In another embodiment of the invention, illustrated in FIG. 6, the elements 600 of the bundle are again arranged longitudinally such that the long axes of a majority of the elements are roughly parallel to one another. The bundle of elements is placed into the casing 602 of a module so that the long axis of the bundle runs perpendicular to the direction of flow of fluid established at one end by the inlet port 604 and on the other end by the outlet port 606. Fluid passes through the spaces around the elements and contacts the surfaces of the elements as it flows from inlet to outlet. Depending upon the nature of the elements, adsorption of components of the fluid or catalysis of reactions involving components of the fluid will occur at the interface between the fluid and the element.

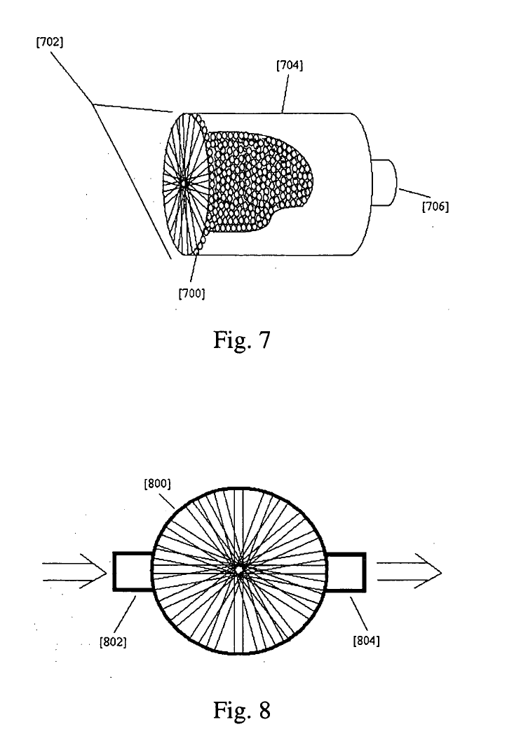

In another embodiment, illustrated in FIG. 7, the elements 700 of a bundle 702 are arranged radially such that the long axis of each element is perpendicular to the long axis of the bundle of elements. The resulting bundle may be placed in the casing 704 of a module such that the long axis of the bundle is oriented along the direction of flow of fluid established by an inlet port at one end and an outlet port 706 at the other end.

In another embodiment, illustrated in FIG. 8, the bundle of the embodiment illustrated in FIG. 7 instead may be placed in the casing 800 of a module such that the long axis of the bundle is perpendicular to the direction of flow of fluid established by an inlet port 802 at one end and an outlet port 804 at the other end.

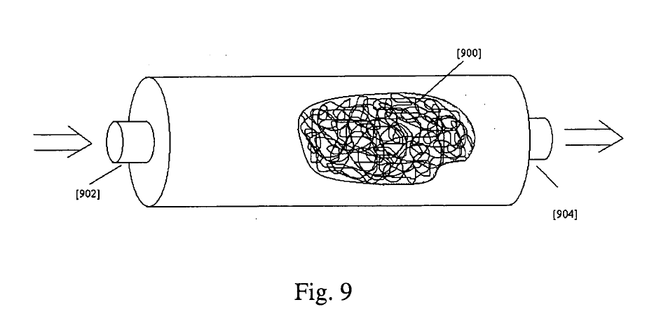

In another embodiment, illustrated in FIG. 9, the elements 900 of a bundle are oriented randomly relative to one another. Fluid enters the module through an inlet port 902, passes through the spaces between the randomly oriented elements, and exits (possibly with a decreased amount of a component adsorbed by the elements or possibly with the product of a chemical reaction catalyzed by the elements) through an outlet port 904.

The present disclosure describes a number of new, useful and nonobvious features and/or combinations of features that may be used alone or together to provide a fluid adsorber or catalytic reactor. The embodiments described herein are all exemplary, and are not intended to limit the scope of the inventions in any way. It will be appreciated that the inventions described herein can be modified and adapted in various ways and for different uses, and all such modifications and adaptations are included in the scope of this disclosure and the appended claims.

We claim:

1. A module comprising:
a casing comprising at least one inlet and at least one outlet;
a bundle of elongated elements located inside the casing, the bundle having empty spaces between at least some of the elongated elements; and
wherein one or more of the elements comprise an adsorbent or a catalytic material.

2. The module of claim 1, wherein the elongated elements comprise one or more fibers, filaments, strands, threads, or strips of material.

3. The module of claim 1, wherein the elongated elements comprise respective long axes, and the long axes of the majority of the elongated elements are roughly parallel to one another.

4. The module of claim 3, wherein the long axes of the majority of the elongated elements are generally parallel to an axis connecting the at least one inlet and the at least one outlet.

5. The module of claim 3, wherein the long axes of the majority of the elongated elements are generally perpendicular to an axis connecting the at least one inlet and the at least one outlet.

6. The module of claim 1, wherein the bundle of elongated elements comprises a central long axis, and the elongated elements comprise respective long axes, and the long axes of a majority of the elongated elements are roughly perpendicular to the central long axis of the bundle.

7. The module of claim 6, the central long axis of the bundle is generally parallel to an axis connecting the at least one inlet and the at least one outlet.

8. The module of claim 6, the central long axis of the bundle is generally perpendicular to an axis connecting the at least one inlet and the at least one outlet.

9. The module of claim 1, wherein one or more of the elongated elements comprises chitosan.

10. The module of claim 9, wherein the elongated elements have a thickness of about 0.010 mm to about 0.250 mm, and a width of about 0.5 mm to about 4.0 mm.

11. The module of claim 9, wherein the elongated elements have a thickness of about 0.015 mm to about 0.125 mm, and a width of about 1.5 mm to about 2.0 mm.

12. The module of claim 9, wherein the elongated elements comprise chitosan fibers having a diameter of about 0.01 mm to about 3.00 mm.

13. The module of claim 1, wherein the bundle of elongated elements has a diameter of about 0.4 cm and a length of about 15 cm.

14. The module of claim 1, wherein the bundle of elongated elements has a diameter of at least about 0.4 cm and a length of at least about 15 cm.

15. The module of claim 1, wherein the casing has a diameter of about 0.4 cm and a length of about 15 cm.

16. The module of claim 1, wherein the casing has a diameter of at least about 0.4 cm and a length of at least about 15 cm.

17. The module of claim 1, further comprising a second bundle of elongated elements located inside the casing.

18. The module of claim 17, wherein the second bundle of elongated elements is substantially identical to the first bundle of elongated elements.

19. A method for removing a substance from a fluid, the method comprising passing a fluid comprising one or more substances through a casing, the casing having therein a bundle of elongated elements comprising one or more materials capable of adsorbing the one or more substances, the bundle having empty spaces between at least some of the elongated elements through which the fluid passes.

20. The method of claim 19, wherein the elongated elements are generally parallel to one another.

21. The method of claim 20, wherein passing the fluid through the casing comprises passing the fluid in a direction generally parallel to the elongated elements.

22. A method for catalyzing a chemical reaction, the method comprising passing a fluid comprising one or more reactants through a casing, the casing having therein a bundle of elongated elements comprising one or more materials capable of catalyzing a chemical reaction involving the one or more reactants, the bundle having empty spaces between at least some of the elongated elements through which the fluid passes.

23. The method of claim 22, wherein the elongated elements are generally parallel to one another.

24. The method of claim 23, wherein passing the fluid through the casing comprises passing the fluid in a direction generally parallel to the elongated elements.
